(19) United States
(12) Patent Application Publication
(10) Pub. No.: US 2012/0168381 A1
(43) Pub. Date: Jul. 5, 2012

(54) Enhanced Clarification Media

(75) Inventors: Senthil Ramaswamy, Nashua, NH (US); Brian Gagnon, Billerica, MA (US); Maybelle Woo, Braintree, MA (US); KS Cheng, Nashua, NH (US); Mikhail Kozlov, Belmont, MA (US)

(73) Assignee: EMD MILLIPORE CORPORATION, Billerica, MA (US)

(21) Appl. No.: 13/414,746

(22) Filed: Mar. 8, 2012

Related U.S. Application Data
(62) Division of application No. 13/102,079, filed on May 6, 2011.
(60) Provisional application No. 61/332,351, filed on May 7, 2010.

(51) Int. Cl. B01D 39/18; B01D 15/00

(52) U.S. Cl. 210/663; 210/496

(57) ABSTRACT

Media and devices, such as depth filters including such media, wherein the media is impregnated with a polymer such as a polyallylamine. The resulting device offers strong binding of protein impurities and superior removal of host cell proteins from biological samples.

This application is a divisional of U.S. patent application Ser. No. 13/102,079 filed May 6, 2011, which claims priority of U.S. Provisional Application Ser. No. 61/332,351 filed May 7, 2010, the disclosures of which are incorporated herein by reference.

### BACKGROUND

The embodiments disclosed herein relate to depth filters having impregnated cross-lined polyallylamine.

Depth filters (e.g., gradient-density depth filters) achieve filtration within the depth of the filter material. A common class of such filters is those that comprise a random matrix of fibers, bonded (or otherwise fixed) to form a complex, tortuous maze of flow channels. Particle separation in these filters generally results from entrapment by, or adsorption to, the fiber matrix. In gradient-density depth filters, several fiber-based filter materials (e.g., in mat or pad format) of different average nominal pore size are arranged sequentially in progressively increasing retentiveness.

Cellulosic depth filters, such as Millistak®+ filters commercially available from Millipore Corporation, are typically used in the production of biopharmaceuticals, as derived from mammalian cell culture for the purpose of clarifying various crude product fluids. These composite filters include a layer of tightly structured cellulosic depth media, and can be optimized to a specific application, such as retaining colloidal particles and cell debris or retaining whole cells and larger debris. They combine sequential grades of media in a single filter cartridge. These filters are most commonly used in polishing or secondary clarification processes to remove small quantities of suspended matter from aqueous product (protein) streams. The primary function of these filters is to protect or extend the service life of more expensive downstream separation processes, such as sterile filtration and affinity chromatography. That is, a common application for these filters is as “prefilters”, protecting downstream process capacity (the volume of fluid that can pass through the filter before it plugs) from colloidal contaminants and other cell debris, which can greatly extend the life of the downstream process. In addition, such depth filters are also used for the protection of viral clearance filters by removing trace quantities of agglomerated proteins.

The filter media typically employed in these depth filters includes refined cellulose fibers (wood pulp), diatomaceous earth, and a water-soluble thermoset resin binder. The diatomaceous earth (a natural form of silica containing trace amounts of various silicates) in these composites is typically 40-60% by weight, and is believed to be the essential component, adsorbing colloidal size biological matter such as cell fragments, organelles and agglomerated proteins, as well as that of various soluble biochemicals such as proteins, lipids and nucleic acids.

Clarification media such as Millistak+® media are extensively used to clarify cell-culture feeds post centrifugation. Depth filters typically work to remove particulate contaminants via size-based capture and adsorption utilizing short-range interactions coupled with some ion-exchange capacity. However, the capacity of these depth filters for soluble impurities such as host cell protein is negligible. Although these filters have demonstrated the ability to reduce turbidity, they have limited throughput (measured by increase in permeate turbidity) and capacity for dissolved impurities such as host cell proteins (HCP) and DNA. As feed titers of monoclonal antibodies and recombinant proteins increase, resulting in increased impurity loading, there is an urgent need to enhance the capacity of depth filters to reduce excessive loads on the downstream process.

It therefore would be desirable to develop a depth filter with significantly higher capacity for HCP, DNA and the like.

### SUMMARY

The problems of the prior art have been overcome by the embodiments disclosed herein, which provide media having impregnated therein a polymer such as a polyallylamine, and methods of purifying biological samples using such media. In certain embodiments, the media comprises a depth filter impregnated with cross-linked polyallylamine. The polyallylamine gel inside the filter can significantly improve the capacity of the filter for certain species such as HCP and DNA, thus providing a benefit for the clarification or purification of biological feedstocks. The resulting depth filter surprisingly offers stronger binding of protein impurities and superior removal of host cell proteins from biological samples than conventional non-impregnated depth filter media. The depth filter may also include quaternary amine based ligands.

In certain embodiments, a method is disclosed to significantly increase the sorptive capacity of depth filters by impregnating (e.g., coating or otherwise incorporating in) the filter material with a loosely cross-linked hydrogel. The resulting filters remove certain species such as host cell proteins (HCPs) from biological samples such as solutions of monoclonal antibodies (MABs). Polymeric primary amines, preferably aliphatic polymers having a primary amine covalently attached to the polymer backbone, more preferably having a primary amine covalently attached to the polymer backbone by at least one aliphatic group, preferably a methylene group, bind negatively charged species such as impurities exceptionally strongly and thus are the preferred class of materials for creating the adsorptive hydrogel which impregnates the depth filter.

In certain embodiments, the depth filters can be provided in a multi-layer format in a suitable housing such as a cartridge, and can be disposable.

### BRIEF DESCRIPTION OF THE DRAWINGS

FIG. 1 is a graph of host cell protein concentration vs. column volume; and

FIG. 2 is a graph of DNA concentration vs. column volume.

### DETAILED DESCRIPTION OF SPECIFIC EMBODIMENTS

The embodiments disclosed herein relate to depth filters impregnated with a porous, polymeric coating. The depth filters are particularly suited for the robust removal of low-level impurities from manufactured biotherapeutics, such as monoclonal antibodies, to reduce excessive loads on downstream purification processes. Typical impurities include DNA, endotoxin, HCP and viruses. The media functions well at high salt concentration and high conductivity (high affinity), effectively removing impurities even under such conditions. High binding capacity with sufficient device permeability is achieved.

Absorption refers to taking up of matter by permeation into the body of an absorptive material. Adsorption refers to movement of molecules from a bulk phase onto the surface of an adsorptive media. Sorption is a general term that includes both adsorption and absorption. Similarly, a sorptive material or sorption device herein denoted as a sorber, refers to a material or device that both ad- and absorbs.

The porous components of the depth filter (e.g., cellulose, diatomaceous earth) act as a supporting skeleton for the adsorptive hydrogel. Suitable materials include cellulose, such as in the form of a random matrix of fibers, diatomaceous earth, silica, porous glass, zeolites, and activated carbon. Suitable binders include thermoset binders, and thermoplastic binders such as polyolefins, preferably polyethylene, polypropylene or mixtures thereof. The binder is preferably used in bead, powder or fiber form. The media fabrication process is known in the art, and generally depends on the binder form used. The media can be prepared by blending the binder with the adsorbent material, followed by fusing the adsorbent particles together such as by partially melting or softening the binder. A wet-laid process can be used to form the media, particularly where the binder is in the form of fibers or consists of a thermoset resin dissolved in the aqueous slurry of cellulose fibers and/or diatomaceous earth.

The impregnating polymer forms the adsorptive hydrogel and bears the chemical groups (binding groups) responsible for attracting and holding the impurities. Alternatively, the polymer possesses chemical groups that are easily modifiable to incorporate the binding groups. It is permeable to biomolecules so that proteins and other impurities can be captured into the depth of the filter, increasing adsorptive capacity. The preferred polymer is a polymeric primary amine. Examples of suitable polymeric primary amines include polyallylamine, polyvinylamine, polybutylamine, polylysine, their copolymers with one another and with other polymers, as well as their respective protonated forms. Polyallylamine (and/or its protonated form, for example polyallylamine hydrochloride (PAH)) has been found to be particularly useful. PAA is commercially available (Nitto Boseki) in a number of molecular weights, usually in the range from 1,000 to 150,000, and all these can be used for creating a depth filter. PAA and PAH are readily soluble in water. The pH of aqueous solution of PAA is about 10-12, while that of PAH is 3-5. PAA and PAH may be used interchangeably, however the pH of the final solution must be monitored and if necessary adjusted to the value above 10 so that non-protonated amino groups are available for reaction with a cross-linker.

The impregnated polymer typically constitutes at least about 3% of the total volume of the depth filter, preferably from about 5% to about 10%, of the total volume of the depth filter, but can be as high as about 50%.

A cross-linker reacts with the polymer to make the latter insoluble in water and thus held within the supporting skeleton. Suitable cross-linkers are difunctional or polyfunctional molecules that react with the polymer and are soluble in the chosen solvent, which is preferably water. A wide variety of chemical moieties react with primary amines, most notably epoxides, chloro-, bromo-, and iodoalkanes, carboxylic acid anhydrides and halides, aldehydes, α,β-unsaturated esters, nitriles, amides, and ketones. A preferred cross-linker is polyethylene glycol diglycidyl ether (PEG-DGE). It is readily soluble in water, provides fast and efficient cross-linking, and is hydrophilic, neutral, non-toxic and readily available. The amount of cross-linker used in the impregnating solution is based on the molar ratio of reactive groups on the polymer and on the cross-linker. The preferred ratio is in the range from about 10 to about 1,000, more preferred from about 20 to about 200, most preferred from about 30 to about 100. More cross-linker will hinder the ability of the hydrogel to swell and will thus reduce the sorptive capacity, while less cross-linker may result in incomplete cross-linking, i.e. leave some polymer molecules fully soluble.

A surfactant may be used to help spread the polymer solution uniformly within the supporting structure. Preferred surfactants are non-ionic, water-soluble, and alkaline stable. Fluorosurfactants possess a remarkable ability to lower water surface tension. These surfactants are sold under the trade name ZONYL by E.I. du Pont de Nemours and Company and are particularly suitable, such as ZONYL FSN and ZONYL FSH. Another acceptable class of surfactants is octylphenol ethoxylates, sold under the trade name TRITON X by The Dow Chemical Company. Those skilled in the art will appreciate that other surfactants also may be used. The concentration of surfactant used in the solution is usually the minimum amount needed to lower the solution surface tension to avoid dewetting. Dewetting is defined as spontaneous beading up of liquid on the surface after initial spreading. The amount of surfactant needed can be conveniently determined by measuring contact angles that a drop of solution makes with a flat surface made from the same material as the porous skeleton. Dynamic advancing and receding contact angles are especially informative, which are measured as the liquid is added to or withdrawn from the drop of solution, respectively. Dewetting can be avoided if the solution is formulated to have the receding contact angle of 0°.

A small amount of a neutral hydrophilic polymer that readily adsorbs on a hydrophobic surface optionally may be added to the solution as a spreading aid. Polyvinyl alcohol is the preferred polymer and can be used in concentrations ranging from about 0.05 wt. % to about 5 wt. % of total solution volume.

When the supporting porous structure cannot be readily wetted with the solution of polymer, a wetting aid can be added to the solution. The wetting aid can be any organic solvent compatible with the coating polymer solution that does not negatively affect the cross-linking reaction. Typically the solvent is one of the lower aliphatic alcohols, but acetone, tetrahydrofuran, acetonitrile and other water-miscible solvents can be used as well. The amount of the added organic solvent is the minimum needed to effect instant wettability of the porous structure with the polymer solution. Exemplary wetting aids include methyl alcohol, ethyl alcohol, and isopropyl alcohol.

The above described surfactants, neutral hydrophilic polymers, and wetting aids are primarily needed when a hydrophobic porous structure is used for coating/impregnation. Conversely, very hydrophilic porous structures, such as cellulose-based depth filters, will not require addition of these components. In practice, it may preferable to avoid using surfactants or neutral hydrophilic polymers to minimize the cost and time needed for their extraction. Also, addition of alcohol wetting aid to coating/impregnation formulation may necessitate the use of explosion-proof equipment thus increasing the cost of the process.

A preferred process for forming the impregnated filter may comprise the steps of: 1) preparing the solution; 2) applying the solution on the depth filter; removing excess liquid from the external surfaces of the depth filter; 3) drying the filter; 4) curing the filter; 5) rinsing and drying of the filter; 6) optional annealing of the finished filter; and 7) optional acid treatment of the filter. More specifically, a solution is prepared that contains a suitable polymer and cross-linker. The concentrations of these two components determine the thickness and degree of swelling of the impregnated polymer, which in turn define flux through the depth filter and its sorptive capacity. The polymer and cross-linker are dissolved in a suitable solvent, preferably water. The solution may optionally contain other ingredients, such as wetting aids, spreading aids, and a pH adjuster. Finally, depending on the chemical nature of the cross-linker, the pH may need to be raised in order to effect the cross-linking reaction. Drying can be carried out by evaporation at room temperature or can be accelerated by applying heat (Temperature range of about 40-110° C.). After the filter is dried, it can be held for a period of from several hours to several days so that cross-linker can fully react with the polymer. Cross-linking may be optionally accelerated by applying heat. The structure is subsequently rinsed with copious amounts of solvent and dried again. Additional optional process steps include annealing the structure at an elevated temperature (60-120° C.) to adjust its flow properties and treating it with a strong non-oxidizing monobasic acid at concentration 0.1M to 1M to protonate the amino groups present.

Where the polymer is PAA, converting essentially all amino groups in the polymer into corresponding ammonium salts after curing and/or heat treatment of the depth filter will help ensure consistency of the product. A strong, non-toxic, non-oxidizing acid, preferably one that is monobasic to avoid ionic cross-linking of PAA, should be used to protonate PAA for this purpose. Suitable acids include hydrochloric, hydrobromic, sulfamic, methansulfonic, trichloroacetic, and trifluoroacetic acid. Although chloride may be the counter-ion of choice since it is already present in the sample protein solution, it may not be practical for a continuous process to use hydrochloric acid and/or its salt due to the corrosion of steel and the occupational safety issues involved. A more suitable acid is thus sulfamic acid (H₂N—SO₂OH) is preferred as the protonating agent for PAA.

A suitable process for protonating the PAA is to submerge the structure in a 0.1-0.5 M solution of the protonating acid, preferably sulfamic acid in water (or a water/alcohol mix to fully penetrate a poorly wetting structure), followed by rinsing and drying. The resulting filter will bear sulfamate counter-ions, which may be easily exchanged out by employing a simple conditioning protocol, such as 0.5M sodium hydroxide followed by 0.5M sodium chloride.

Such acid treatment improves shelf life stability of the filter, and also results in a significantly higher strength of binding. Although the present inventors should not be limited to any particular theory, it is believed that when PAA is dried in the fully protonated (acid-treated) state, it assumes a more extended, “open” morphology that is capable of better encapsulating BSA and HCP and thus will not release it until a higher ionic strength is reached. A further benefit of acid-treated filter is greater stability towards ionizing irradiation, such as gamma irradiation, which is an accepted sterilization procedure for filtration products.

Another important aspect is a post-treatment procedure employed after the filter is cured, rinsed, and dried. Treatment of the filter based on polymeric primary amines with acid significantly boosts its strength of binding, wettability, and stability towards ionizing radiation.

The permeability of the cross-linked PAA filter can be improved by a high-temperature “curing” process. The lightly cross-linked PAA-gel has the ability to absorb significant amount water resulting in orders of magnitude increase in its volume. This effect can cause low permeability. It appears that this property of the gel is reduced by dehydrating it to such an extent that it reduces the swelling to an acceptable level, without compromising the strength of binding and capacity of the gel. In fact, the curing process is capable of tuning the permeability as necessary for the product. Suitable curing temperatures are about 25-120° C., more preferably from about 85-100° C.; and for about 6 to 72 hours.

The following examples are included herein for the purpose of illustration and are not intended to limit the invention.

### Example 1

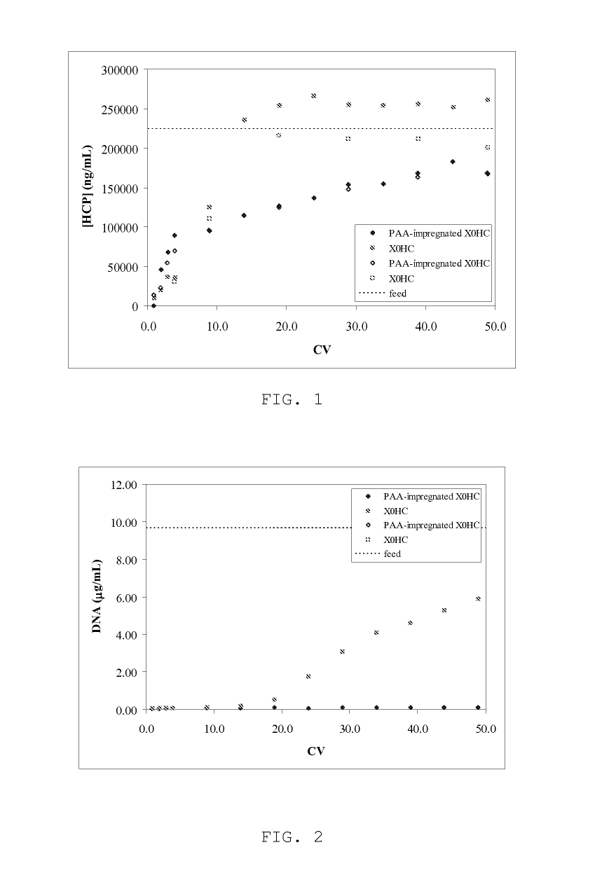

The depth filter materials used to make Millipore's X0HC range of Millistak® media comprise of cellulose fibers and diatomaceous earth held together with a polyamine binder were used. Two layers of this type of media are stacked to form a depth filter unit. In this example, the two layers of the X0HC filter media were impregnated with PAA solution having the composition described in Table 1. The filters were air dried and then extracted with Milli-Q water. Next, the filters were treated with 0.3 M sulfamic acid, washed with water, and redried. The two layers were incorporated into an approximately 25 mm diameter device. Non-expressing CHOs feed spiked with polyclonal human IgG was used to test the PAA-impregnated devices; X0HC devices were also tested for comparison. A typical value for feed pH at this is stage is around 7.5 and for conductivity is around 10.4 mS/cm. The devices were loaded with the feed and fractions were collected for HCP and DNA analysis. As seen in FIG. 1, the HCP removal of the PAA-impregnated X0HC is better than that of the neat X0HC. In FIG. 2, the PAA-impregnated X0HC removes significantly more DNA as compared to the neat X0HC.

TABLE 1
Coating solution composition

| chemical | grams |
|---|---|
| 15% polyallylamine (free base) | 120 |
| in water | |
| Water | 280 |
| polyethylene glycol diglycidyl | 2.4 |
| ether | |

What is claimed is:

1. A depth filter comprising a housing containing a matrix of cellulose fibers impregnated with a crosslinked polymer having attached primary amine groups.

2. The depth filter of claim 1, wherein said matrix further comprises diatomaceous earth.

3. The depth filter of claim 1, wherein said crosslinked polymer comprises polyallylamine or a protonated polyallylamine.

4. The depth filter of claim 1, wherein said crosslinked polymer comprises a copolymer or block copolymer containing polyallylamine or a protonated polyallylamine.

5. The depth filter of claim 2, wherein said cellulose fibers and said diatomaceous earth are held together by a binder.

6. A method of removing impurities from a biological sample, comprising filtering said sample through porous sorptive media comprising cellulose impregnated with a crosslinked polymer having attached primary amine groups.

7. The method of claim 6, wherein said biological sample comprises a solution having a pH of about 7.5.

8. The method of claim 6, wherein said biological sample comprises a solution having a conductivity of about 10.4 mS/cm.
